(19) United States
(12) Patent Application Publication
(10) Pub. No.: US 2011/0264614 A1
(43) Pub. Date: Oct. 27, 2011

(54) Human Expert Assisted Evolutionary Computational Model

(76) Inventor: Richard D. Gardner, Scottsdale, AZ (US)

(21) Appl. No.: 12/765,958

(22) Filed: Apr. 23, 2010

(51) Int. Cl. G06N 3/12

(52) U.S. Cl. 706/13

(57) ABSTRACT

This invention outlines a method to extend computer-based evolutionary learning algorithms by supplementing with human reasoning rather than pure computational logic. Evolutionary algorithms such as genetic algorithms and neural networks are global search heuristics. These algorithms use techniques inspired by evolutionary biology such as inheritance, mutation, selection, crossover, neuronal pruning and adaption for identifying exact or approximate solutions to optimization and search problems. This invention discloses a method of allowing humans, who are experts in the domains of certain problems, to interact with and propose theories that are used as constraints to evolutionary algorithms and to provide feedback that may allow evolutionary algorithms to escape local minima during the evolutionary computing process.

### BACKGROUND OF THE INVENTION

1. Field of the Invention

This invention pertains to the field of data analysis for identifying exact or approximate solutions to optimization and search problems using an evolutionary learning system with the aid of human experts.

2. Description of Related Art

Evolutionary algorithms such as genetic algorithms and neural networks are global search heuristics. These algorithms use techniques inspired by evolutionary biology such as inheritance, mutation, selection, crossover, neuronal pruning and adaption for identifying exact or approximate solutions to optimization and search problems.

What is needed is a method of allowing humans, who are experts in the domains of certain problems, to interact with and propose theories that are used as constraints to evolutionary algorithms and to provide feedback that may allow evolutionary algorithms to escape local minima during the evolutionary computing process.

### SUMMARY OF THE INVENTION

This invention pertains to enabling an evolutionary learning algorithm to use human reasoning for constraints and for escaping local minima which is neither evolutionary computing nor distributed artificial intelligence in general.

In an exemplary embodiment of the present invention, there is disclosed a method implemented by one or more computers, including one or more processors that have been programmed with instructions that cause the computer(s) to optimize and combine or recombine theories, rules or constraints provided by one or more human experts, comprises:

providing data by one or more computers to constitute a database providing example training data for an evolutionary learning algorithm; and

calculating values related to the fitness of the solution relative to the problem(s) presented by the human expert(s).

In another embodiment of the present invention, there is disclosed a computer program product for use with a computer, the computer program product including a computer readable medium having recorded thereon a computer program or program code for causing the computer to perform a method implemented by one or more computers, including one or more processors that have been programmed with instructions that cause the computer(s) to optimize and combine or recombine theories, rules or constraints provided by one or more human experts, comprising:

providing data by one or more computers to constitute a database providing example training data for an evolutionary learning algorithm; and

calculating values related to the fitness of the solution relative to the problem(s) presented by the human expert(s

In another embodiment of the present invention, there is disclosed a system implemented by one or more computers, including one or more processors that have been programmed with instructions that cause the computer(s) to optimize and combine or recombine theories, rules or constraints provided by one or more human experts, comprises:

providing data by one or more computers to constitute a database providing example training data for an evolutionary learning algorithm; and

calculating values related to the fitness of the solution relative to the problem(s) presented by the human expert(s).

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow chart of an outline of a program code that a Human experts would write to describe theories; and

FIG. 2 is a flow chart of a theory drawn by a human expert onto a workspace using a computer mouse or other user-input method such as a touch screen or voice recognition.

### DESCRIPTION OF THE PREFERRED EMBODIMENT

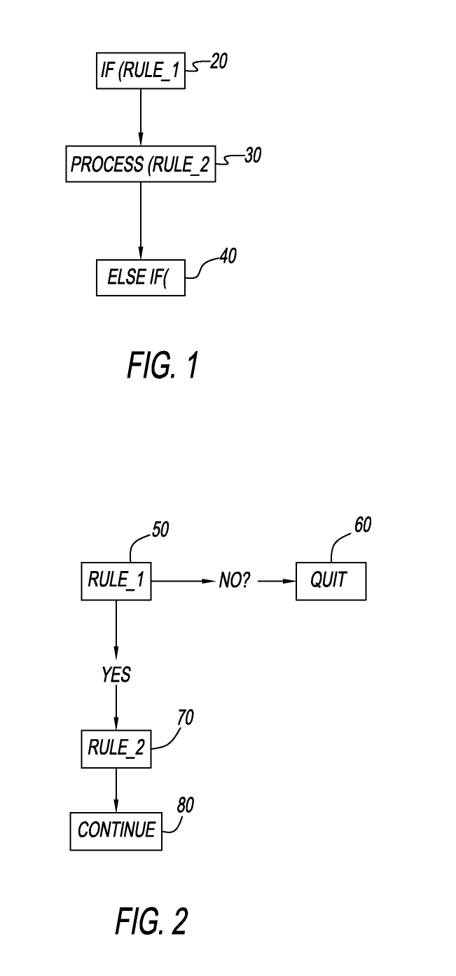

Two possible methods in which human experts may create rules that describe problems or theories that may potentially help solve the problems is by using a flow chart of an outline of a program code that a Human experts would write to describe theories as is shown by FIG. 1, or where a flow chart of a theory is drawn by a human expert onto a workspace using a computer mouse or other user-input method such as a touch screen or voice recognition as is shown by FIG. 2.

Referring to FIG. 1, at block 20 an, if (rule 1), is proposed. From block 20 the program advances to block 30, process (rule 2), and then to block 40 where, else if(, is processed. From block 40 the process continues until a result is obtained.

Referring to FIG. 2, at block 50 a rule 1 is proposed. If the result is NO, the process stops, block 60. If however the result is YES, the process advances to block 70 and the process is continued, block 80.

This invention discloses a method and system of extending computer-based evolutionary learning systems with human reasoning instead of pure computational logic.

Reason and logic can be thought of as distinct. Reason is a type of rational thought, which cannot be simulated by computers. Logic involves the attempt to describe rules by which reason operates, so that orderly reasoning can be taught.

Author Douglas Hofstadter, in Gödel, Escher, Bach, Vintage, 1979, ISBN 0-394-74502-7 characterizes the distinction in this way. Logic is done inside a system while reason is done outside the system by such methods as skipping steps, working backward, drawing diagrams, looking at examples, or seeing what happens if you change the rules of the system.

Another way to consider the confusion between logic and reason is that unlike humans, computers and animals sometimes perform actions which are apparently logical: from a complex set of data, conclusions are achieved which are “logical”. Being a cause of something which humans find logical does not necessarily mean that computers or animals use reasoning or even logic in the strict sense.

Human reason is much more specific, requiring not just the possibility of associating perceptions of smoke, for example, with memories of fire, but also the ability to create and manipulate a system of symbols, as well as indices and icons, according to Charles Sanders Peirce, the symbols having only a nominal, though habitual, connection to either smoke or fire. Reasons for Action: “Justification vs. Explanation” at the Stanford Encyclopedia of Philosophy.

Computer-based evolutionary learning algorithms are iterative and consist of the repetition of an algorithmic body which, given a set of candidate rules, consist of effecting elementary operations of modification on these rules, evaluating their quality in relation to different criteria and constraints, and selecting the most satisfactory.

One of the particularities of the proposed implementation is the use of human experts for defining the initial problem(s), for defining one or more theories that may help solve the problem and for providing input and feedback to the evolutionary learning algorithm when requested by the program in order to escape local minima during the evolutionary process.

The embodiment(s) of the invention disclosed is for illustration and is not intended to define or limit the invention in any way whatsoever.

The logical first step in the process is for one or more human experts to define one or more optimization or search problems to solve. This may be achieved either in program code as depicted in FIG. 1 or by other means of user input as depicted in FIG. 2. During this step, human expert(s) may define the types of acceptable answer(s) such as yes/no, true/false, a numeric value, etc. The data source for training datasets must also be defined.

Human expert(s) are then allowed to define one or more theories or premises that will be used to constrain or guide the learning algorithm. Theories may be represented in program code as depicted in FIG. 1 or may be represented visually as depicted in FIG. 2. The theories may be based on human reasoning and knowledge of the underlying problem. Each theory may optionally have one or more variable parameters, which may be modified by the learning algorithm.

One or more human expert(s) may configure and start the learning algorithm. The algorithm may be configured to run locally on only one computer, or in a distributed computing environment consisting of multiple computers connected across a wired or wireless network.

The evolutionary learning algorithm begins to calculate and optimize rules by combining and recombining theories, fragments of theories or variables of theories. The theories should generally be related by some type of relationship or classification.

A particularity of this invention is that the learning algorithm may halt or temporarily suspend evolution for a specific portion of the system (if necessary) in order to request human feedback, in an effort to escape local minima. Human expert(s) may suggest a modification to the problematic theory or provide a completely new theory, thereby allowing the learning algorithm to possibly escape local minima and resume computation.

It is important to note that the particularities of the underlying learning algorithm are of little to no concern in this invention, as any type of evolutionary learning algorithm may be used, such as a genetic algorithm, a neural network or another algorithm or any variation.

Calculation and learning may be indefinite, as the learning algorithm may only be expected to reduce the error between the actual output values and the expected results provided in the training database. Human expert(s) may ultimately decide when to terminate the system.

The results may be displayed on a graph, stored in a spreadsheet, database, printed, or used in real time in an out-of-sample environment. How the results are used is not a concern of this invention.

As will be appreciated by one skilled in the art, the present invention may be in the form of a system, a method or a computer program product. Thus, the invention disclosed may be in hardware, in software, or in hardware and software, or may be in the form of a computer program product having computer readable program code located thereon.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method implemented by one or more computers, including one or more processors that have been programmed with instructions that cause the computer(s) to optimize and combine or recombine theories, rules or constraints provided by one or more human experts, comprises:
providing data by one or more computers to constitute a database providing example training data for an evolutionary learning algorithm; and
calculating values related to the fitness of the solution relative to the problem(s) presented by the human expert(s).

2. The method of claim 1, wherein a simulated annealing option allows the evolutionary learning algorithm to apply more or less weight to an individual human expert's theories or constraints based on the overall error contribution of the individual human expert.

3. The method of claim 1, wherein calculation of at least one modified theory or rule or variable belonging to a theory also minimizes the error between an expected result and the calculated solution.

4. The method of claim 1, wherein at least one initial theory or rule includes a logical combination of premises, each including one or more constraints relating to an expected solution.

5. The method of claim 1, wherein one of the fitness functions is defined by one or more human experts.

6. The method of claim 1, wherein determining the objectives is defined by one or more human experts.

7. The method of claim 1, further comprising:
providing selection and invariance of a part of elementary premises of an initial rule or set of rules.

8. The method of claim 1, wherein the evolutionary learning algorithm may request feedback from a human expert to modify or remove portions of the training data set, in an effort to escape local minima.

9. The method of claim 1, wherein the evolutionary learning algorithm may request feedback from a human expert to modify, remove or add theories or premises in an effort to escape local minima.

10. The method of claim 1, further comprising:
providing a setting that allows the system to be run on either a local computer or in a distributed computing environment consisting of multiple computers connected across a wired or wireless network.

11. The method of claim 1, further comprising:
providing the ability to allow human experts to reuse and extend existing theories by appending additional constraints or premises to the existing theories.

12. A computer program product for use with a computer, the computer program product including a computer readable medium having recorded thereon a computer program or program code for causing the computer to perform a method implemented by one or more computers, including one or more processors that have been programmed with instructions that cause the computer(s) to optimize and combine or recombine theories, rules or constraints provided by one or more human experts, comprising:
providing data by one or more computers to constitute a database providing example training data for an evolutionary learning algorithm; and
calculating values related to the fitness of the solution relative to the problem(s) presented by the human expert(s).

13. A system implemented by one or more computers, including one or more processors that have been programmed with instructions that cause the computer(s) to optimize and combine or recombine theories, rules or constraints provided by one or more human experts, comprises:
providing data by one or more computers to constitute a database providing example training data for an evolutionary learning algorithm; and
calculating values related to the fitness of the solution relative to the problem(s) presented by the human expert(s).
